(19) United States
(12) Patent Application Publication
(10) Pub. No.: US 2021/0167624 A1
(43) Pub. Date: Jun. 3, 2021

(54) Adaptive Magnetic Wireless Charger

(71) Applicant: Shen Zhen Shi Aiker Electronic Technology co., LTD., Shenzhen (CN)

(72) Inventor: Yao Su, Wanyuan (CN)

(73) Assignee: Shen Zhen Shi Aiker Electronic Technology co., LTD.

(21) Appl. No.: 17/170,926

(22) Filed: Feb. 9, 2021

(30) Foreign Application Priority Data
Jan. 19, 2021 (CN) 202120131910.9

(51) Int. Cl. H02J 7/02; H02J 50/10

(52) U.S. Cl. CPC H02J 7/02; H01F 38/14; H02J 50/10

(57) ABSTRACT

An adaptive magnetic wireless charger comprises a charging dock and a power line. A wireless charging module is arranged in the charging dock, an accommodating cavity is defined around the charging dock by a partition plate, the power line is connected to the wireless charging module, a holding plate is disposed in the accommodating cavity, a magnetic and a spring are mounted on the holding plate, and one end of the spring abuts against an inner top surface of the charging dock.

### BACKGROUND OF THE INVENTION

### 1. Technical Field

The invention relates to the technical field of wireless chargers, in particular to an adaptive magnetic wireless charger.

### 2. Description of Related Art

With the continuous development of science and technology, wireless chargers, as a new charging technique, have been widely applied to different electronic products, particularly mobile phones. The wireless chargers are ceaselessly innovated to be applied to products more easily.

At present, there are two wireless charging techniques for mobile phones, where one is non-magnetic charging, and the other one is magnetic charging. Magnetic wireless charging docks with a magnetic wireless charging function are typically used for charging mobile phones supporting the magnetic charging function. However, when a mobile phone only supporting a wireless charging function, but not supporting a magnetic function is placed on the magnetic wireless charging dock to be charged, charging can be realized, but it may deviate from the charging dock due to lack of magnetic correction, and a magnetic of the charging dock is close to a wireless coil of the mobile phone, the magnetic field generated by the magnet may interfere with electromagnetic waves generated by the wireless coil, thus affecting the charging efficiency.

### BRIEF SUMMARY OF THE INVENTION

The objective of the invention is to overcome the defects of the prior art by providing an adaptive magnetic wireless charger.

To fulfill the aforesaid objective, the invention adopts the following technical solution:

An adaptive magnetic wireless charger comprises a charging dock and a power line, wherein a wireless charging module is arranged in the charging dock, an accommodating cavity is defined around the charging dock by a partition plate, the power line is connected to the wireless charging module, a holding plate is disposed in the accommodating cavity, a magnetic and a spring are mounted on the holding plate, and one end of the spring abuts against an inner top surface of the charging dock.

Preferably, an anti-slip mat is arranged at the bottom of the charging dock.

Preferably, the elastic force of the spring is smaller than the attractive force between the magnet and a magnetic ring of a mobile phone.

By adoption of the above solution, the holding plate is disposed in the accommodating cavity to install the magnet, and the spring is arranged to provide an ejection force, so that when not attracted, the magnet will be retained at the bottom of the accommodating cavity to satisfy the charging requirement of conventional wirelessly rechargeable mobile phones, the interference of the magnet on wireless charging magnetic waves is reduced, and the wireless charging efficiency is guaranteed; when a mobile phone supporting the magnetic wireless function is placed on the adaptive magnetic wireless charger, a magnetic ring in the mobile phone will attract the magnet in the charging dock, the spring is compressed, and the holding plate moves upwards to satisfy the magnetic wireless charging requirement of the mobile phone; and the adaptive magnetic wireless charger is simple in overall structure, easy to operate, and good in practicability.

### BRIEF DESCRIPTION OF THE SEVERAL VIEWS OF THE DRAWINGS

FIG. 1 is a structure and principle diagram according to one embodiment of the invention.

FIG. 2 is a structure diagram of non-magnetic charging according to one embodiment of the invention.

FIG. 3 is a structure diagram of magnetic charging according to one embodiment of the invention.

### DETAILED DESCRIPTION OF THE INVENTION

The embodiments of the invention will be explained in detail below in conjunction with the accompanying drawings, but the invention can also be implemented in other different manners defined and included by the claims.

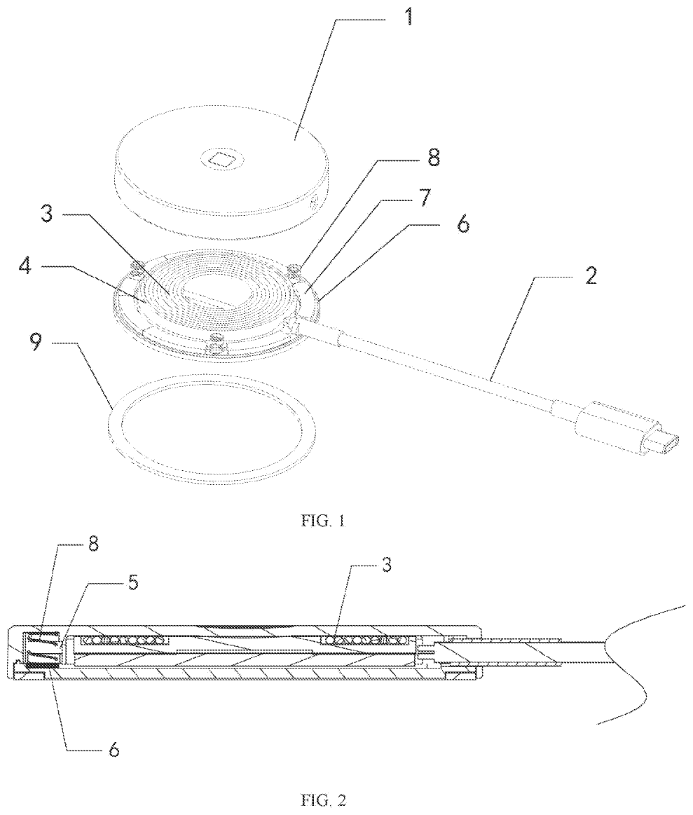

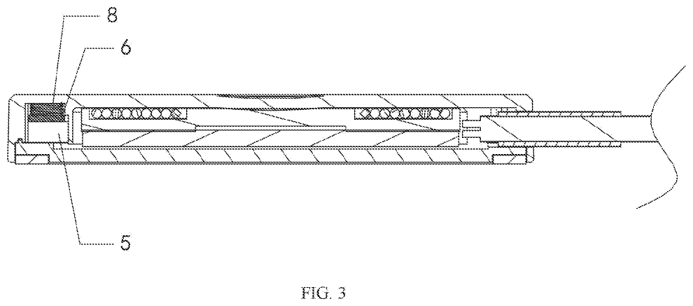

As shown in FIG. 1 to FIG. 3, this embodiment provides an adaptive magnetic wireless charger, comprising a charging dock 1 and a power line 2, wherein a wireless charging module 3 is arranged in the charging dock 1, an accommodating cavity 5 is defined around the wireless charging module 3 by a partition plate 4, the power line 2 is connected to the wireless charging, module 3, a holding plate 6 is disposed in the accommodating cavity 5, magnets 7 and springs 8 are mounted, on the holding plate 6, and one end of each spring 8 abuts against an inner top surface of the charging dock 1. Wherein, the elastic force of the springs 8 is smaller than the attractive force between the magnets 7 and a magnetic rig of a mobile phone.

The adaptive magnetic wireless charger in this embodiment has the following two states in use:

First, when the adaptive magnetic wireless charger is used for charging a mobile phone merely supporting the wireless charging function, the mobile phone is placed on the charging dock 1, at this moment, the holding plate 6 will be kept at the bottom of the accommodating cavity 5 under the elastic force of the springs 8 and stays away from a wireless charging coil in the mobile phone, and the magnets 7 located on the holding plate 6 are also kept away from the wireless charging coil in the mobile phone, so that the interference from the magnets 7 is reduced, thus improving the wireless charging effect of the mobile phone.

Second, when the adaptive magnetic wireless charger is used for charging a mobile phone supporting the magnetic wireless charging function, the mobile phone is placed on the charging dock 1, at this moment, a magnetic ring in the mobile phone will attract the magnets 7 located on the holding plate 6 upwards, the holding plate 6 moves upwards accordingly, the springs 8 are compressed, and in this way, the magnetic wireless charging function is realized by means of mutual attraction of the magnets 7 and the magnetic ring in the mobile phone. When the mobile phone is taken away from the charging dock 1, the magnets 7 on the holding plate 6 will be released, the springs 8 rebound, and the holding plate 6 abuts against the bottom of the accommodating cavity 5 again.

Furthermore, to prevent the charging dock 1 from slipping, an anti-slip mat 9 is arranged at the bottom of the charging dock 1 in this embodiment.

The above embodiments are merely preferred ones of the invention, and are not intended to limit the patent scope of the invention. All equivalent structures or equivalent process transformations obtained according to the contents of the specifications and the accompanying drawings, or direct or indirect applications to other relating technical fields should also fall within the patent protection scope of the invention.

What is claimed is:

1. An adaptive magnetic wireless charger, comprising a charging dock and a power line, wherein a wireless charging module is arranged in the charging dock, an accommodating cavity is defined around the charging dock by a partition plate, the power line is connected to the wireless charging module, a holding plate is disposed in the accommodating cavity, a magnetic and a spring are mounted on the holding plate, and an end of the spring abuts against an inner top surface of the charging dock.

2. The adaptive magnetic wireless charger according to claim 1, wherein an elastic force of the spring is smaller than an attractive force between the magnet and a magnetic ring of a mobile phone.

3. The adaptive magnetic wireless charger according to claim 1, wherein an anti-slip mat is arranged at a bottom of the charging dock.
